(19) United States
(12) Patent Application Publication
(10) Pub. No.: US 2008/0016704 A1
(43) Pub. Date: Jan. 24, 2008

(54) Cutting tools

(76) Inventor: Hisatsugu Henry Haneda, Tacoma, WA (US)

Correspondence Address: William J. McNichol;Reed Smith, LLP, P.O. Box 7990, Philadelphia, PA, 19101, US

(21) Appl. No.: 11/489,704

(22) Filed: Jul. 18, 2006

(51) Int. Cl. B26B 9/02

(52) U.S. Cl. 30/357

(57) ABSTRACT

The present invention is a cutting tool having a cutting feature formed along substantially all of a cutting edge formed along a portion of the blade of the edged tool. The cutting feature is characterized by a cutting edge, a first thickness behind the cutting edge, and a second thickness behind the first thickness, with the second thickness being less than the first thickness. The second thickness is preferably established within the first 20% of the depth of the blade adjacent the cutting edge.

### BACKGROUND

The present invention relates to the field of cutting implements, and more particularly to cutting tools used to slice soft materials and the like.

Knives having a sharpened cutting edge have been used for many years in the preparation of foods or the cutting of soft materials. Typically, such knives have a blade with a sharpened edge along one or more of the edges of the blade, with the sharpened edge being formed by grinding or honing the edge to form two surfaces joined at an acute angle. Such a blade is easy to manufacture, however it may have limitations with regard to cutting some soft materials, including many foodstuffs.

As a knife is forced into material to be cut, the cutting edge acts as a wedge, which forces apart the portion of material being cut from the remaining portion of the material. Until the portion being cut off is fully severed from the main portion one or both portions may bear against the sides of the knife being used to cut the material. As the knife is forced further into the material, friction between the material and the sides of the knife both increases the force required to force the knife through the material, and also creates shear forces that are applied to the material being cut. Such shear forces can distort the cut surface of the material, causing ripping or tearing which damages the material being cut, potentially rendering the cut material unusable or simply reducing its aesthetic qualities.

As shown in FIG. 1, in order to minimize the forces generated between the cutting tool 100 and the material, various efforts have been made to reduce the surface contact between the material and the cutting tool 100. One solution has been to form kullens 102 in one or both sides of the blade 104. Kullens 102 are concave dimples formed in the surface 106 of the knife, used to reduce contact between the knife surface 106 and the material being cut. As shown in FIG. 1B, the kullens 102 form thinned sections 108 in the blade 104 above the cutting edge, such that contact between the material and the sides of the blade 104 above the cutting edge 110 are reduced, such that friction forces are reduced.

The formation of kullens in one or both sides of the blade gives rise to several disadvantages. First, frequent sharpening of the blade wears the cutting edge to the point that the cutting edge becomes formed from the thinned blade sections formed by the kullens (shown as the dashed line 112 in FIG. 1), as well as by the ribs 114 between the individual kullens 102. FIG. 2 shows a knife 200 having kullens 102 that has been sharpened to the point that the cutting edge 110 extends through the kullens 102. Along a first plane 202, shown in cross-section as FIG. 2A, the rib 114 between kullens 102 causes the sharpened blade to be thicker adjacent 204 the cutting edge 110, while along a second plane 206, shown in cross-section as FIG. 2B, the kullens themselves cause the thickness 208 of the blade 104 immediately adjacent the cutting edge to be thinner, affecting the performance of the blade 104 when the knife 200 is used for slicing. Such a cutting edge has significant limitations, particularly in that the cutting edge no longer has a substantially constant cross section, and any lateral motion of the knife as material is cut causes the raised portions of the cutting edges formed by the ribs 114 to alternately further force the opening between the main portion and the portion being cut to separate and reclose, creating localized increases in the friction between the material being cut and the knife 200, as well as localized increases in the shear forces applied to the material being cut. This may result in a ripping, ragged cut that also requires greater effort by the users of the knife.

A second disadvantage arises from the process used to form the kullens 102 in the blade 104. The metals used to form knife blades tend to be very hard, but brittle, metals. Where the kullens 102 are machined into a blade 104, the machining may leave stress concentrations in the structure of the blade 104 that are subject to forming cracks, a propensity which is enhanced by the hard but brittle materials. Where the kullens 102 are formed by a stamping process, stress concentrations again may be formed, giving rise to a similar crack propensity. The more transitions that are formed in the blade geometry, the greater the number of stress concentrations, and accordingly, the more susceptible the blade is to cracking.

### SUMMARY OF THE INVENTION

The present invention may be embodied in a cutting tool having a blade. The blade may be characterized as having a length, a depth, and a cutting edge extending along at least a portion of the length of the blade. The blade may have a cross sectional shape adjacent the cutting edge that is consistent long the cutting edge. The cross sectional shape may be characterized by the presence of a first thickness above the cutting edge, and a second thickness above the first thickness, where the second thickness is less than the first thickness, such that the reduced thickness in the area of the second thickness reduces surface contact between the cutting tool and material being cut when the cutting tool is used to cut such material.

Alternately, the present invention may be embodied in a cutting tool having a blade. The blade may be characterized as having a length, a depth, and a cutting edge extending along at least a portion of the length of the blade. The blade may be further characterized as having a cutting feature extending along the cutting edge, wherein the cutting edge is characterized by a sharpened edge, a first thickness above the sharpened edge, and a second thickness above the first edge, wherein the second thickness is less than the first thickness, and the second thickness is achieved close to the sharpened edge.

Alternately, the present invention may be embodied in a cutting tool having a blade characterized as having a length, a depth, and a cutting edge extending along at least a portion of the length of the blade, with the blade further having a recess formed in a first side of the blade. The recess may extend along at least 50% of the cutting edge, such that a wedge portion is established between the cutting edge and the recess. The wedge portion may have a first thickness at its thickest extent. A second blade thickness may be established by the recess, such that the first blade thickness is greater than the second blade thickness.

Alternately, the present invention may be embodied in a cutting tool having a blade characterized as having a length, a depth, and a cutting edge extending along at least a portion of the length of the blade, with the blade further having a scab joined to the blade on a first side blade, adjacent to the cutting edge. The scab may be characterized as having a length and a first edge and a second edge and a scab width extending between the first edge and the second edge, with the scab extending along at least 50% of the cutting edge. The first edge of the scab may be disposed adjacent to the cutting edge. The scab may establish a first thickness through the blade and the scab adjacent to the second edge of the scab. The blade may have a second thickness immediately above the first thickness, with the second thickness being less than the first thickness.

Alternately, the present invention may be embodied in a cutting tool having a blade characterized as having a length, a depth, and a cutting edge extending along at least a portion of the length of the blade. The blade may further include a scab having a v-shaped cross section. The v-shaped cross section may be characterized as having first and second legs. The first leg and the second leg may each have a first end and a second end, with the first leg being joined to the second leg at the first end of each leg to form an acute angle. The first leg and the second leg may each have a length extending from the respective first ends to the respective second ends, as well as a thickness. The length of the first leg and/or the length of the second leg may be less than 10% of the depth of the blade, with the v-shaped scab conforming to the cutting edge of the cutting tool and extending along at least 40% of the cutting edge. The first and second legs may form a first thickness at the outermost extent of the first and second legs. The thickness of the blade adjacent to an uppermost extent of the first and second legs may be less than the first thickness.

Alternately, the present invention may be embodied in a cutting tool having a blade characterized as having a length, a depth, and a cutting edge extending along at least a portion of the length of the blade, with the blade further having a first scab joined to the blade on a first side adjacent to the cutting edge. The first scab may have a length and a first edge, a second edge, and a first scab width extending between the first edge and the second edge. The first scab may extend along at least 50% of the cutting edge, with the first edge of the first scab being disposed adjacent to the cutting edge. The blade may additionally have a second scab joined to the blade on a second side of the blade, adjacent to the cutting edge. The second scab may also have a length, a first edge, a second edge, and a second scab width extending between the first edge and the second edge, with the second scab extending along at least 50% of the cutting edge, with the first edge of the second scab being disposed adjacent to the cutting edge. The cutting tool may be characterized as having a has a first thickness through the blade and the first and second scabs adjacent to the second edges of the first and second scabs, and a second thickness immediately above the first thickness, with the second thickness being less than the first thickness.

### BRIEF DESCRIPTION OF THE FIGURES

FIG. 1 illustrates a prior art knife using a plurality of kullens to reduce the thickness of the blade behind the cutting edge.

FIG. 1A illustrates a notional cross section of the prior art knife of FIG. 1, with the cross-section taken through a rib between adjacent kullens.

FIG. 1B illustrates a notional cross-section of the prior art knife of FIG. 1, with the cross-section taken through a kullen.

FIG. 2 illustrates the prior art knife of FIG. 1 after repeated sharpenings.

FIG. 2A illustrates a notional cross section of the prior art knife of FIG. 2, with the cross-section taken through a rib between adjacent kullens.

FIG. 2B illustrates a notional cross-section of the prior art knife of FIG. 1, with the cross-section taken through a kullen.

FIG. 3 illustrates a cutting tool with a recess formed adjacent the cutting edge.

FIG. 3A illustrates the cutting tool of FIG. 3 in cross-section.

FIG. 3B illustrates the cutting tool of FIG. 3, showing a close-up of the cutting edge in cross-section.

FIG. 4 illustrates a cutting tool such as shown in FIG. 3 after repeated sharpenings of the cutting edge.

FIG. 4A illustrates the cutting tool of FIG. 3 in cross-section.

FIG. 5 illustrates a cutting tool utilizing a scab on one side of the blade.

FIG. 5A illustrates the cutting tool of FIG. 5 in cross-section.

FIG. 6 illustrates the cutting tool of FIG. 5 in cross section after repeated sharpenings.

FIG. 7 illustrates a cutting tool utilizing a v-shaped scab on the cutting edge.

FIG. 7A illustrates the cutting tool of FIG. 7 in cross-section.

FIG. 8 illustrates the cutting tool of FIG. 7 in cross section after repeated sharpenings.

FIG. 9 illustrates a cutting tool utilizing multiple recesses.

FIG. 9A illustrates a cutting tool as shown in FIG. 9 in cross-section.

FIG. 9B illustrates a cutting tool such as shown in FIG. 9, showing a close-up of the cutting edge in cross-section.

FIG. 10 illustrates a recess formed in a cutting tool, such as the cutting tool shown in FIGS. 3 and/or 9, shown in cross section, embodying a cross-sectional shape optimized to rapidly transition the edge of the blade from the wedge portion to the recess.

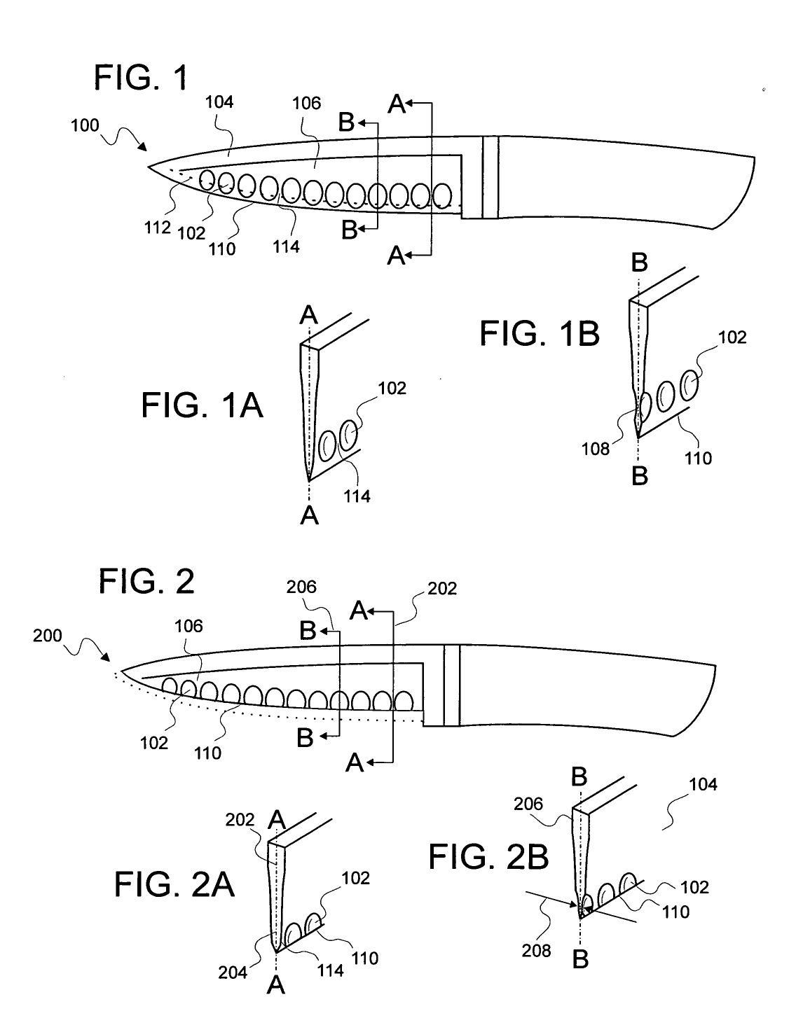

### DETAILED DESCRIPTION OF THE INVENTION

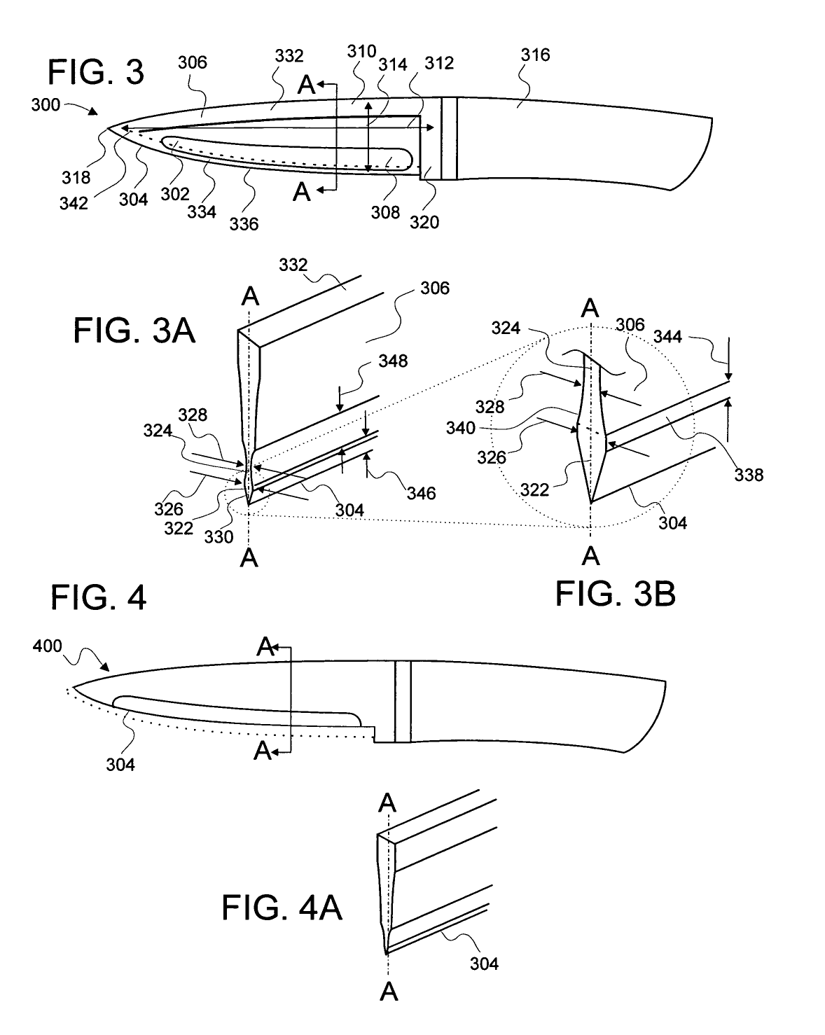

In order to provide a more full understanding of the present invention, embodiments of the invention are shown in FIGS. 3 through 10, which are described in detail as provided below.

With respect to the embodiment of FIG. 3, in which like numbers represent like elements, there is shown a cutting tool 300 having a thinned section 302 formed immediately behind the cutting edge 304 of a blade 306. The thinned section 302 may be a recess 308 formed in one side 310 of the blade 306, such that the area of surface contact between the blade 306 and a material being cut is substantially reduced. The blade 306 may have a length 312 and a depth 314, as well as a handle 316, and may come to a point 318 or not. The shape of the blade 306 and the style of the handle 316 may be varied as desired. The thinned section 302 of the blade 306 may typically extend along the majority of the length 312 of the cutting edge 304 of the blade 306. The blade 306 may have a choil 320 between the cutting edge and the handle 316.

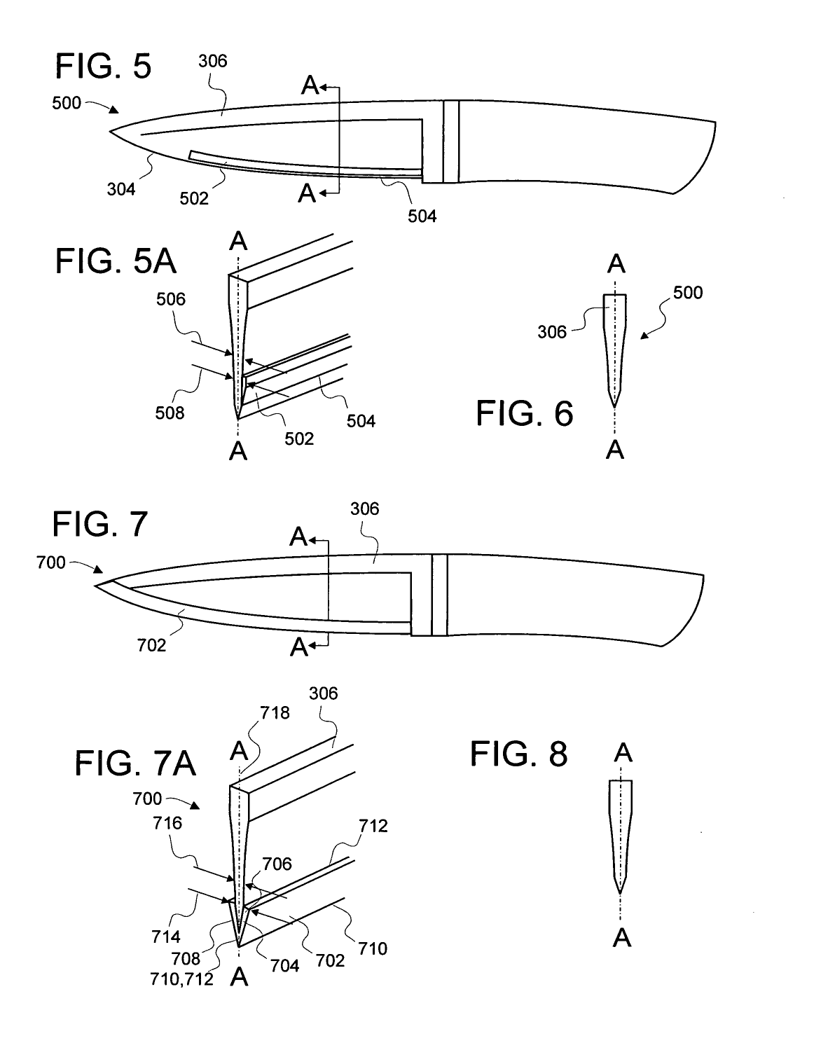

The thinned section 302 feature may be formed as a recess 308 on one or both sides of the blade 306 during initial fabrication of the blade 306, such as during a stamping or forging process by which the blade 306 is formed. Alternately, the thinned section 302 may be formed through a forming process, such as by grinding, machining or milling a recess into the blade. Alternately, as shown in FIGS. 5 and 7 and discussed further below, the thinned section may be created by the addition of material to one or both sides of the blade adjacent the cutting edge, thus thickening the blade adjacent the edge.

The purpose of the thinned section 302 is to reduce the surface contact between the material being cut and the side or sides of the blade 306. Accordingly, when viewed in cross-section such as shown in FIG. 3A, the blade 306 may include a first portion 322 and a second portion 324, with the second portion 324 being above the first portion 322 with respect to the cutting edge 304. The thickness 326 of the first portion is greater than the thickness 328 of the second portion 324, such that the wedge 330 formed by the cutting edge 304 stops where the first portion 322 transitions to the second portion 324, such that material that has already been cut, and has passed the first thickness 326, does not contact the sides of the blade 306 in the area of the second thickness 328. In order for the blade 306 to have adequate strength, the blade 306 may additionally be provided with a thicker section, such as a spine 332, to provide strength or stiffness to the blade 306. In the area of the spine 332, the thickness of the blade 306 may equal or exceed the first thickness 326, such that cut material may once again come into contact with the blade 306. The above is not intended to be construed, however, to infer the requirement of a spine 332, as the thickness of the knife 300 may remain less than the first thickness 326 for the full extent of the blade 306 above the first portion 322. Additionally, the cross-section of the blade above the cutting feature 334 formed by the first 322 ad second 324 portion may vary, so long as the cross-section of the blade 306 adjacent the cutting feature 334 retains the relationship between the first and second thicknesses 322, 324.

Furthermore, it must be noted that the cut portion of material being cut tends to form an angle with respect to the remaining portion of material, such that the transition from the cutting edge 304 to the first thickness 326 tends to separate the material being cut, and thus from being in surface contact with the blade 306, such that the thickness of the blade 306 above the second thickness 328 can increase the farther above the cutting edge 304 the blade 306 goes, without promoting surface contact between the blade 306 and the material being cut.

As shown in FIG. 3, the cutting feature 334 may be seen as a section of the blade 306 between a recess 308 and the cutting edge 304 including the cutting edge, such that the cutting feature 334 may extend along most of the cutting edge 304. As shown in FIG. 3A, the cross section of the cutting feature may include a sharpened edge 336. The sharpened edge 336 may be formed by grinding, honing, or any other process suitable for generating a sharpened edge 336. A first thickness 326 may be formed behind the cutting edge 304 to force material being cut apart. A second thickness 328 may be formed above the first thickness 326. The second thickness 328 is less than the first thickness 326, such that a gap may be formed between the material being cut, after having been forced apart by the first thickness 326, and the sides 338, 340 of the cutting tool 300 in the area of the second thickness.

Frequent use may result in the cutting tool being sharpened to the point that sufficient material has been removed such that the first portion 322 has been essentially removed, such as to the dashed line 342 shown in FIG. 3. FIG. 4 illustrates a cutting tool 300 such as shown in FIG. 3 that has been sharpened to such an extent. As shown in FIG. 4A, a cutting edge 304 may be formed from the remaining material after the first portion has been sharpened away, allowing the cutting tool 400 to continue to be used after the first portion has been worn away by successive sharpenings.

As shown more clearly in FIG. 3B, the first portion 322 may additionally or alternately extend for a distance 344, such that material is provided to allow some sharpening of the cutting feature 334 before material removal associated with such sharpening begins to reduce the first thickness 326. The length 344 of the side surfaces 338, 340 of the first portion 322 may be chosen to provide for an optimal ability of the cutting tool 300 to be successively sharpened, without the side surfaces 338, 340 extending for such a length that surface contact between the material being cut and the side surfaces is adversely increased. The length 344 of the side surfaces 338, 340 is therefore dependant upon the speed at which material may be worn away from the blade 306 by sharpening operations, the overall depth 314 of the blade 306, and the desire to minimize the length of the side surfaces 338, 340 to limit friction between the side surfaces 338, 340 and material being cut.

As shown in FIG. 3, the thinned section may extend from the cutting edge above the first portion 322 across a substantial portion of the depth 314 of the blade 306 itself. The blade 306 may additionally have a spine 332. The spine 332 may have a greater thickness than the thinned section 302, to give strength to the blade 306. A second edge may be formed on the back edge of the blade 306 if a double sided cutting tool is desired. The second cutting edge may additionally be formed to have a thick portion and a thin portion behind the second cutting edge.

The proportions of the depth of the first portion 322 to the width of the thinned section 302 to the depth 314 of the blade 306 may be chosen to provide an optimized cutting tool for a particular application. In one presently preferred embodiment, the width 348 of the recess is approximately ⅓^{rd} to ⅕^{th} of the depth 314 of the blade 306, when a machined recess is used 346. Additionally, the depth of the first portion 322 may be between 3 and 6 millimeters, however these dimensions are chosen for the cutting of soft foodstuffs, and the dimensions may be varied as required to accommodate different materials and knife sizes.

As shown in FIG. 4, the cutting tool 400 of the present invention may be sharpened to the point that sufficient material removal has occurred to remove all of the first portion. Such excessive sharpening does not obviate the utility of the cutting tool, however, as the sharpened edge 304 still provides a smooth contour, unlike what may occur with respect to kullens, as discussed above.

As shown in FIG. 5, the first thickness may alternately be formed by bonding or joining a scab 502 or scabs to one or both sides of the blade 306 adjacent the cutting edge 304. The scab 502 or scabs may preferably extend along most of the cutting edge 304 of the blade 306. The scab 502 or scabs may preferably be joined to the blade 306 such that the junction of the scab 502 or scabs to the blade 306 adjacent the cutting edge 304 present a smooth transition, such that sharpening of the cutting edge which extends into the scab 502 or scabs allows the sides of the blade 306 to retain a smooth surface adjacent the transition 504 from the cutting edge 304 to the scab 502 or scabs.

A scab 502 may be joined to only one side of the blade 306, such as shown in FIGS. 5 and 5A, without preventing surface contact from being reduced between the side of the blade of the knife and material being cut. Additionally, the use of a scab 502 or scabs in such fashion allows the remaining portion of a hollow ground blade to form a rotational recess, such that the thickness 506 of the blade 306 above where the scab 502 has been attached is thinner that than the thickness 508 of the joined scab 502 and blade 306, as shown in FIG. 5A. Additionally, as shown in FIG. 6, the cutting tool again does not lose its utility if the scab 502 is completely worn away by sharpening, as the remaining portion of the blade 306 may present a conventional knife cross-section, which while without enjoying the benefit of the present invention, may still be usable for some cutting actions.

The scab 502 or scabs may be joined to the blade 306 through any method which provides suitable joint strength to prevent the scab 502 from becoming separated from the blade 306 during any cutting or sharpening procedures. Presently, joining the scab 502 to the blade using an epoxy based adhesive has proved suitable, especially when a blade 306 material that is difficult to weld is being used. Where the selected blade material shows ready weldability, ultrasonic welding may be utilized to create a joint of sufficient structural strength between the scab 502 and the blade 306.

The blade 306 of the present invention does not need to be formed from a metallic material, although the ready availability of metallic materials may lead to implementation of metallic materials as a cost decision. The blade 306 and/or scab 502 may alternately or additionally be formed from zirconium ceramics, tungsten carbide, or more conventional metals. Where metals are used, various heat treatments or surface hardening treatments may be used to obtain specific properties as desired. Presently, prototypes of the blade 306 of the present invention have been formed used ZDP-189, a proprietary metallurgy produced by Hitachi. ATS-34, another proprietary metallurgy produced by Hitachi, is also believed highly suitable for producing cutting tools implementing the present invention.

As shown in FIG. 7A, a scab 702 having a v-shaped cross section 704 may be utilized. The v-shaped cross section 704 may have first 706 and second 708 legs joined at first ends 710, 712 of the legs 706, 708, such that a sharpened edge 710 may be formed at the intersection of the legs 706, 708. As the legs 706, 708 are angled with respect to each other, the legs 706, 708 can form an outermost extent 712, which establishes a first thickness 714. Above where the v-shaped scab 702 is joined to the blade 306, the absence of the material forming the legs creates a thinner section 716 of the blade 306 complex, such that the surface contact reduction of the present invention is accomplished. Although the illustrations show the scab 702 being symmetrical with respect to the centerline 718 of the blade, the cross-section 704 does not need to be symmetrical, and further may vary along the length of the scab, i.e., the length of the legs may decrease or increase as desired as the scab 702 extends along the cutting edge. As shown in FIG. 8, the use of a v-shaped scab also provides the benefit of leaving a conventional knife cross-section after the scab has been worn away by sharpening, which although not providing the benefits of the present invention, allows the cutting tool to continue to be used.

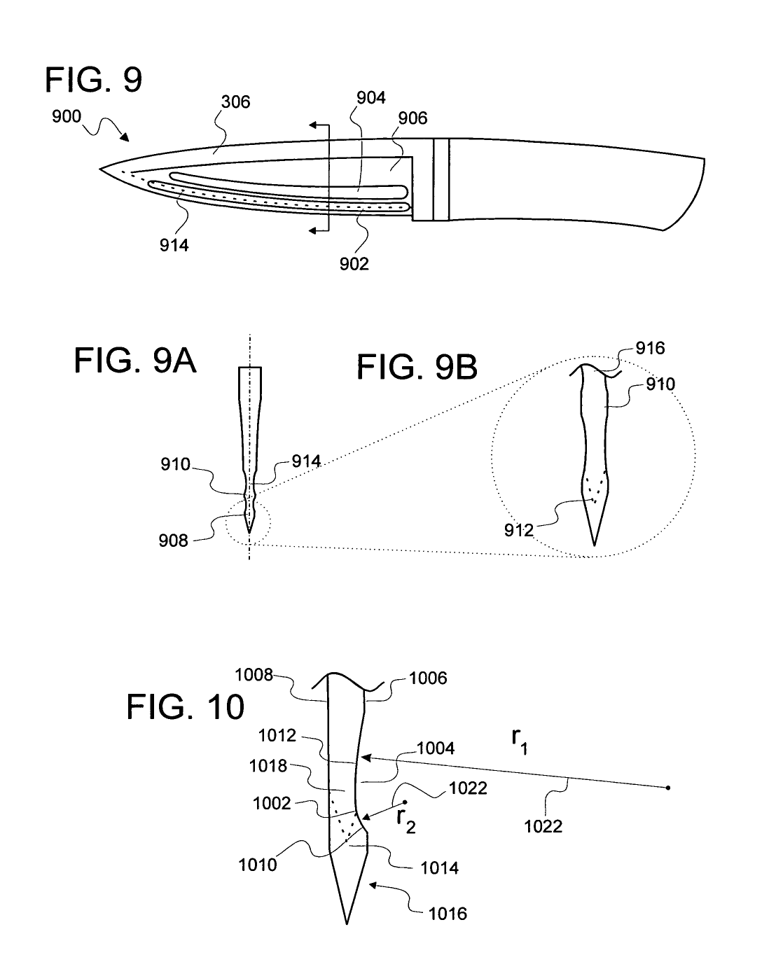

As shown in FIG. 9, multiple recesses 902, 904 may be formed in the side 906 of a blade 306, such that when a first thick portion 908 has been worn away through sharpening, a second thick portion 910, as shown in FIG. 9A, forms the new cutting edge 912 shown in FIG. 9B. As shown in FIG. 9B, where the cutting tool 900 has been sharpened to the point that material has been removed to the dashed line 914 shown in FIG. 9, a thick portion 910 still exists above the cutting edge 912, with a thin portion 916 behind the thick portion 910.

As shown in FIG. 10, the profile 1002 of a recess 1004 is not limited to arcuate or other forms. Indeed, the use of scabs as shown in FIGS. 5 and 7 illustrates that the creation of a thin portion of the blade above a thick portion may be accomplished without requiring any material removal from the blade. Notwithstanding, where it is desired to utilize a recess 1004 formed on one or more sides 1006, 1008 of a blade, the profile 1002 of the recess 1004 may be formed in two arcuate sections 1010, 1012 with the arcuate section joining the thick portion 1014 of the cutting feature 1016 with the thin portion 1018 having a smaller radius 1020 than the radius 1022 Of the remainder of the arc (or other suitable contour) which forms the recess 1004. The use of a rapid transition from the thick portion 1014 to the thin portion 1018 may assist in minimizing surface contact between material being cut and the sides of the blade of a knife, as well as provide a transition which limits or minimizes stress concentrations from forming in the area of the transition.

The present invention may be embodied in other specific forms than the embodiments described above without departing from the spirit or essential attributes of the invention. Accordingly, reference should be made to the appended claims, rather than the foregoing specification, as indicating the scope of the invention.

What is claimed is:

1. A cutting tool, said cutting tool comprising:
a blade, said blade having a depth, a length and a cutting edge extending along substantially all of said length;
said blade having a cross-sectional shape which extends along said cutting edge, and which includes a first portion above the cutting edge, and a second portion which is thinner than the first portion located above the first portion; and
wherein the cross-sectional shape reduces surface contact between a material being cut and the blade when the blade is used to cut such material.

2. A cutting tool according to claim 1, wherein the cross-sectional shape extends substantially continuously along 50% of the cutting edge.

3. A cutting tool according to claim 1, wherein the thickness of the second portion is less than 70% of the thickness of the first portion.

4. A cutting tool according to claim 1, wherein the second portion extends through at least 15% of the depth of the blade.

5. A cutting tool according to claim 4, wherein the first portion extends through less than 20% of the depth of the blade.

6. A cutting tool according to claim 5, wherein second portion establishes a thinned section of said blade, and wherein said thinned section of said blade is established within 20% of the depth of the blade from the cutting edge.

7. A cutting tool according to claim 6, wherein the thinned section of said blade is established within 10% of the depth of the blade form the cutting edge.

8. A cutting tool according to claim 7, further comprising a third portion above said second portion, said third portion being thicker than said second portion, and a fourth portion above said third portion, said fourth portion being thinner than said third portion.

9. A cutting tool according to claim 1, wherein said blade has a depth axis, and wherein said first portion is symmetric with respect to said depth axis.

10. A cutting tool according to claim 9, wherein said second portion is symmetric with respect to said depth axis.

11. A cutting tool according to claim 1, wherein said blade has a first side and a second side, said first side having a surface area, and wherein said second portion establishes a thinned section of said blade, said thinned section encompassing at least 20% of the surface area of said first side.

12. A cutting tool according to claim 1, wherein said blade is formed from ZDP 189.

13. An edged tool, said edged tool comprising:
a blade having a length, a depth, and a cutting edge, said cutting edge extending along at least approximately 50% of said length of said blade;
a cutting feature formed along substantially all of said cutting edge, said cutting feature having a cross sectional shape, said cross sectional shape being substantially constant along said cutting edge; and
said cross sectional shape having a sharpened edge, a first thickness behind said sharpened edge, and a second thickness behind said first thickness, wherein said second thickness is less than said first thickness; and
wherein said second thickness establishes a thinned section of the blade, said thinned section being established within 20% of the depth of the blade from the cutting edge.

14. A cutting tool according to claim 13, wherein said blade has a depth axis, and wherein said first portion is symmetric with respect to said depth axis.

15. A cutting tool according to claim 14, wherein said second portion is symmetric with respect to said depth axis.

16. A cutting tool according to claim 13, wherein the thinned section of said blade is established within 10% of the depth of the blade form the cutting edge.

17. A cutting tool according to claim 13, further comprising a third thickness above said second thickness, said third thickness being thicker than said second thickness, and a fourth thickness above said third thickness, said fourth thickness being thinner than said third thickness.

18. A cutting tool according to claim 13, wherein said blade is formed from ZDP 189.

19. A cutting tool having a blade, said blade having a first side, a length and a cutting edge, said cutting edge extending along at least 50% of said length, said blade further comprising a recess in said first side of said blade, said recess extending along at least 50% of said cutting edge, such that a wedge portion is established above said cutting edge between said cutting edge and said recess, said wedge portion having a first blade thickness at its thickest extent, and wherein a second blade thickness is established by said recess, and wherein said first blade thickness is greater than said second blade thickness.

20. A cutting tool according to claim 19, wherein said blade has a blade depth, and wherein said wedge portion has a depth, said wedge portion depth being less than 20% of said blade depth.

21. A cutting tool according to claim 20, wherein said recess has a recess width, and wherein said recess width is at least 10% of said blade width.

22. A cutting tool according to claim 21, wherein the cross-section of the recess is substantially arcuate, said arc having a first arc radius.

23. A cutting tool according to claim 22, wherein the cross section of the recess adjacent the wedge portion is arcuate, said cross section of the recess adjacent a wedge portion having a second arc radius, and wherein said second arc radius is less than said first arc radius.

24. A cutting tool according to claim 23, wherein said second arc radius is less than 10% of sad first arc radius.

25. A cutting tool having a blade, said blade having a first side, a length, a depth and a cutting edge, said cutting edge extending along at least 50% of said length, said blade further comprising a scab having a v-shaped cross section, said v-shaped cross section having first and second legs, said first leg and said second leg each having a first end and a second end, said first leg being joined to said second leg to form an acute angle at said first leg first end and said second leg first end, said first leg and said second leg each having a thickness, and a length, said first leg length and said second leg length each being less than 10% of the depth of said blade, said v-shaped scab conforming to the cutting edge of said cutting tool and extending along at least 40% of said cutting edge, wherein said first and second form a first thickness at the outermost extent of said first and second legs, and wherein the thickness of the blade adjacent to an uppermost extent of said first and second legs is less than the first thickness.

26. A cutting tool according to claim 25, wherein said scab is joined to said blade by an adhesive.

27. A cutting tool according to claim 25, wherein said scab is joined to said blade by said scab being welded to said blade.

28. A cutting tool according to claim 27, wherein said scab is joined to said blade by ultrasonic welding.

29. A cutting tool having a blade, said blade having a first side, a length, a depth and a cutting edge, said cutting edge extending along at least 50% of said length, said blade further comprising a scab joined to said blade on said first side and adjacent to said cutting edge, said scab having a length and a first edge and a second edge and a scab width extending between said first edge and said second edge, said scab length extending along at least 50% of said cutting edge, said first edge being disposed adjacent said cutting edge, and wherein said cutting tool has a has a first thickness through said blade and said scab adjacent said second edge of said scab, and wherein said blade has a second thickness immediately above said first thickness, said second thickness being less than said first thickness.

30. A cutting tool according to claim 29, wherein said scab width is less than 10% of the depth of said blade.

31. A cutting tool having a blade, said blade having a first side and a second side, a length, a depth and a cutting edge, said cutting edge extending along at least 50% of said length, said blade further comprising a first scab joined to said blade on said first side and adjacent to said cutting edge, said first scab having a length and a first edge and a second edge and a first scab width extending between said first edge and said second edge, said first scab length extending along at least 50% of said cutting edge, said first edge being disposed adjacent said cutting edge, said blade further comprising a second scab joined to said blade on said second side and adjacent to said cutting edge, said second scab having a length and a first edge and a second edge and a second scab width extending between said first edge and said second edge, said second scab length extending along at least 50% of said cutting edge, said first edge being disposed adjacent said cutting edge, and wherein said cutting tool has a has a first thickness through said blade and said first and second scabs adjacent said second edges of said first and second scabs, and wherein said blade has a second thickness immediately above said first thickness, said second thickness being less than said first thickness.

32. A cutting tool according to claim 31 wherein said first scab width is substantially equal to said second scab width.

33. A cutting tool according to claim 31, wherein said first scab length is substantially equal to said second scab length.

34. A cutting tool according to claim 31, wherein said first scab is joined to said blade by an adhesive.

35. A cutting tool according to claim 31, wherein said first scab is joined to said blade by said first scab being welded to said blade.

36. A cutting tool according to claim 31, wherein said first scab is joined to said blade by ultrasonic welding.
